(19) United States
(12) Patent Application Publication
(10) Pub. No.: US 2016/0111016 A1
(43) Pub. Date: Apr. 21, 2016

(54) METHOD OF EDUCATIONAL INSTRUCTION

(71) Applicants: Preethi Govindaraj, Williamsville, NY (US); Deepa Govindaraj, Williamsville, NY (US)

(72) Inventors: Preethi Govindaraj, Williamsville, NY (US); Deepa Govindaraj, Williamsville, NY (US)

(21) Appl. No.: 14/980,060

(22) Filed: Dec. 28, 2015

Related U.S. Application Data
(63) Continuation-in-part of application No. 14/029,536, filed on Sep. 17, 2013, now abandoned.

(51) Int. Cl. G09B 19/00; G06F 17/27; G06F 17/21; G09B 5/06; G06F 17/30

(52) U.S. Cl. CPC G09B 19/00; G09B 5/06; G06F 17/30289; G06F 17/212; G06F 17/2785

(57) ABSTRACT

A method of making an educational tool using a computing device having a processor and a memory, the method including steps of associating a trait with a literary style to form a literary style database in the memory; and determining the frequency of an occurrence of an item of a trait in the a text in a pre-determined range; subtracting a pre-determined value from the frequency of occurrence of the item of the trait to result in a difference, wherein if the difference is positive, a relevance value of the trait is obtained by dividing the difference with the pre-determined value and the trait is looked up in the literary style database to identify a literary style; and ordering the item of the trait in a list according to the magnitude of the relevance value such that top traits identified from the text can be presented.

### PRIORITY CLAIM AND RELATED APPLICATIONS

This continuation-in-part application claims the benefit of priority from provisional patent application U.S. Ser. No. 61/702,910 filed on Sep. 19, 2012 and non-provisional application U.S. Ser. No. 14/029,536 filed on Sep. 17, 2013. Each of said applications is incorporated by reference in its entirety.

### BACKGROUND OF THE INVENTION

1. The Field of the Invention

This invention is directed to a comprehensive and multidisciplinary method of educational instruction. In particular, the method of educational instruction is aimed at teachers already in the field, teachers seeking to improve their teaching skills, student teachers, students who are studying to become teachers, daycare instructors, pre-school instructors, paraprofessionals in day care, school administrators, parents, education-related professionals, board members, guidance counselors, speech therapists, nurses, pre-school and K-12, preschool students, K-12 students, and college students.

2. Background Art

In most States, K-12 teachers are required to obtain Master's Degrees in order to teach. Often, the teachers obtain their Master's Degree in the field of educational studies in which they study the process of teaching and pedagogical strategies, but then go on to teach students in content disciplines such as social studies, English literature, science, or math without having studied these particular subjects in college. As a result, many teachers have no practical knowledge about the subject they are teaching and are ill-equipped to teach the students. Rather, teachers who obtained degrees in educational studies learned teaching strategies, classroom management, and superficial application of content. Unfortunately, students of such teachers are receiving subpar education and find themselves unprepared for college-level studies which are deeply rooted in content. As can be seen, there is a need for a method of educational instruction that provides deep content knowledge, which teachers otherwise would not receive in professional development. Presently, teachers may be charged with teaching a particular topic, such as a Shakespearean Sonnet but do not have a chance to learn and explore the Sonnet for themselves as thoroughly as students are expected to explore it. Other professional development programs and methods of instruction provide ‘how to teach’ training programs that are not grounded in content. Further, these programs and methods of instruction are not multidisciplinary.

Thus there is a need to provide a method of instruction that helps teachers understand a topic deeply and critically and to facilitate instructional shifts reflective of deep content knowledge. Moreover, there is a need to provide teachers and students with a similar learning experience. The method of educational instruction provides the teachers with a shared content experience.

### SUMMARY OF THE INVENTION

Accordingly, it is the subject of this invention to provide a method of making an educational tool for a user using a computing device having a processor and a memory, the method including steps of associating at least one trait with a literary style to form a literary style database in the memory; and performing text analysis on at least one selected text in the processor, the performing step including: determining the frequency of an occurrence of at least one item of a trait in the selected text in a pre-determined range; subtracting a pre-determined value from the frequency of occurrence of the at least one item of the trait to result in a difference, wherein if the difference is positive, a relevance value of the trait is obtained by dividing the difference with the pre-determined value and the trait is looked up in the literary style database to identify a literary style; and ordering the at least one item of the trait in a list according to the magnitude of the relevance value such that top traits identified from the at least one selected text can be presented to the user.

Further disclosed is a comprehensive and multidisciplinary method of educational instruction that thoroughly equips teachers with the ability to teach their chosen subject. It is envisioned that the method will also be applicable to medical professionals, accountants, attorneys, architects, engineers, scientists, business professionals, and any other professionals that are required to continue education within their field. In particular, the educational method disclosed herein can be applied to target the specific content area of nearly any profession.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1-6 depict screenshots that are displayed on an end user's computer screen.

FIG. 7 depicts a flow chart depicting the operation of an educational tool.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

The term “area of study” as used herein and in the appended claims includes all branches of knowledge that are taught in K-12 classrooms, including, but not limited to, mathematics, government, humanities, science—including earth science, life science, chemistry, physics, and astronomy, art, physical education, languages, economics, literature, and history.

The term “topic” as used herein and in the appended claims includes any subject within an area of study that contributes to advancing the knowledge of that area of study. The term “text” as used herein and in the appended claims includes anything that is used to illustrate a topic. A text may include, but is not limited to, a poem, a book, a song, a movie, a part of a movie, a work of art, documentaries, musical scores, or news pieces. A text may also include portions of books, such as, chapters or excerpts, and may include portions of movies.

The term “author” as used herein and in the appended claims is used to describe the creator of a text.

The term “work” is used herein and in the appended claim is used to refer to particular work created by an author in cases where the text is the author.

The term “category” as used herein and in the appended claims includes, but is not limited to, music, picture books, prose, poetry, and art. Each text fits into one of these categories.

The term “text analysis” means identifying words or phrases or components of the text that are important for understanding the text and ultimately require definitions or explanations for a thorough understanding of the text. The components of the text may include symbols and measures such as those found in a musical score.

The term “scholarship analysis” as used herein and in the appended claims includes reviewing academic journals, articles, books, papers, and other media created by university scholars and field experts outside universities. Additionally, scholarship analysis may include a review of other sources such as newspapers and magazines and online blogs.

The term “text device” is any tool that is used in the text, the identification and explanation of which is important for understanding the text. Text device includes, but is not limited to, literary structure, narrative device, rhetorical device, syntax, linguistic device, poetic meter, alliteration, simile, hyperbole, personification, themes, onomatopoeia, Jamesion center of consciousness, voice (1st person, 2nd person, 3rd person), parabasis, velar, sibilant, plosive, poetic meter and rhythm, stressed/unstressed syllable, cascade, anaphora, epistrophe, direct repetition, incremental repetition, anadiplosis, alliteration, slant rhymes, consonance, assonance, tenses, chiasmus, and parallelism and balance, syntax device, use of commas, dashes, sentence length, conjunctions, colons, semi-colons, question marks, and exclamation points.

The term “text device identification” is the first step in performing the text analysis. First the text device identification is performed. Second the words and phrases or portions of the text that demonstrate the use of at least one text device are selected.

The term “theme” as used herein and in the appended claims is the central or underlying idea of a text.

The term “argument” as used herein and in the appended claims is the author's point of view on a subject within a text.

The term “word choice” as used herein and in the appended claims refers to the word or words chosen by the author.

The term “syntax” as used herein and in the appended claims refers to the arrangement of words and phrases to form phrases or clauses or sentences. Syntax also includes the way in which a sentence is broken up by commas.

The term “sentence construction” as used herein and in the appended claims is the specific task or tasks that parts of the speech perform in a sentence. Sentence construction includes, among others, periodic sentences and loose sentences.

The term “periodic sentence” as used herein and in the appended claims is a complex sentence in which the main clause comes last and is preceded by the subordinate clause.

The term “loose sentence” as used herein and in the appended claims is a complex sentence in which the main clause comes first and the subordinate clause follows.

The term “prosody” as used herein and in the appended claims is the patterns of rhythm and sound used.

The term “pacing” as used herein and in the appended claims is the speeding up or slowing down of language and meter in a text.

The term “rhetorical device” as used herein and in the appended claims is the use of language that creates a literary effect.

The term “narrative device” as used herein and in the appended claims is the method the author of a text uses to convey the plot of the text to an audience.

The term “literary technique” as used herein and in the appended claims is any method the author of a text uses to convey the theme or argument of the text.

The term “central theme” as used herein and in the appended text is the primary or most important theme of a text.

The term “scholarly text” as used herein and in the appended claims includes, but is not limited to books, articles, reviews, and other similar texts, including non-scholarly texts. The term “author's cultural context” as used herein and in the appended text includes, but is not limited to historical context, author's cultural background and how these inform the text through thematic patterns or woes choices, etc.

The term “supporting multimedia” as used herein and in the appended claims includes, but is not limited to author interviews and documentaries on historical context, wherein the interview or documentary is found on YouTube®, NPR®, PRX Public Radio Exchange®, Vimeo®, and other similar channels.

The term “connecting text” as used herein and in the appended claims is a text that isn't being analyzed as part of the text analysis, but is connected by theme and/or argument to the text being analyzed as part of the text analysis.

The term “academic discipline” as used herein and in the appended claims is a branch of knowledge that is taught and researched and includes, but is not limited to, humanities, social sciences, natural sciences, and formal sciences.

The term “academic sub-discipline” as used herein and in the appended claims is a sub-branch of knowledge of each of the academic disciplines. The academic sub-disciplines of humanities includes history, linguistics, literature, performing arts, philosophy, religion, visual arts. The academic sub-disciplines of social sciences includes anthropology, archaeology, geographical area studies, cultural and ethnic studies, economics, gender and sexuality studies, geography, political science, government, psychology, and sociology. The sub-disciplines of natural sciences includes astronomy sciences, earth sciences, life sciences, chemistry, and physics. The sub-disciplines of formal sciences includes computer sciences, logic, mathematics, statistics, and systems sciences. The above list of disciplines and sub-disciplines is illustrative rather than exhaustive. As can be seen, some areas of study can also be disciplines or sub-disciplines or may be independent areas of study.

The term “knowledge” as used herein and in the appended claims describes what is known within an area of study or topic or discipline or sub-discipline.

The term “poetic meter” as used herein and in the appended claims is the basic rhythmic structure of a verse or lines in a verse.

The term “rhyme scheme” as used herein and in the appended claims is the ordered pattern of rhymes at the ends of the lines of a poem or verse.

The term “poetic device” as used herein and in the appended claims is any technique that helps improve the quality of the text, including, but not limited to, alliteration, metaphors, similes, slant rhymes, anaphora, epistrophe, and personification.

The term “illustration” as used herein and in the appended claims includes, but is not limited to, pictures, drawings, sketches, figures, images, prints, artwork, and visual aids.

The term “art” as used herein and in the appended claims includes, but is not limited to, paintings, photographs, sculpture, pottery, embroidery, jewelry, design, miniature art, and carvings.

The term “medium” as used herein and in the appended text includes the type of material used to create the text.

The term “narrative” as used herein and in the appended text is an account or story of the text. The narrative is based on the text analysis.

The term “narration script” as used herein and in the appended claims is a set of instructions for narrators to follow when reading the narrative out loud. The narrative script includes instructions for what words to emphasize and where in the script to pause.

The term “animation script” as used herein and in the appended claims is a set of instructions for animators to follow when an audio of the narration script is playing.

The term “final script” as used herein and in the appended claims is a set of instructions for merging the narration script and animation script.

The term “educational tool” as used herein and in the appended claims includes “animated video tools”, “instructional tools”, and “student tools”.

The term “animated video tool” as used herein and in the appended claims includes an animated video that an end user is able to view that demonstrates the text analysis performed on the text.

The term “instructional tool” as used herein and in the appended claims includes a tool that an end user is able to use on a computer screen that demonstrates the text analysis performed on the text.

The term “student tool” as used herein and in the appended claims includes a tool that combines the features of the animated video tool and the instructional tool.

The term “text video” as used herein and in the appended claims includes, but is not limited to, a digitized screenshot of the text and an actual recorded video of the text.

The term “text annotation” as used herein and in the appended claims includes, but is not limited to changing the color of portions of the text, highlighting, underlining, circling, bracketing, adding symbols to lines of a text, marking, adding arrows to the text, and combinations thereof. In some embodiments, text annotation can include the incorporation of another text for comparison to the text that is being analyzed.

The term “text definition” as used herein and in the appended claims includes a visual definition of selected words in the text, wherein the definition is located above, below, or next to the text.

The term “supporting illustration” as used herein and in the appended claims includes providing at least one illustration either from the text or from a source external to the text.

The term “text manipulation” as used herein and in the appended claims includes, but is not limited to magnification of text, underlining of text, identification of stressed and unstressed syllables, annotations, highlighting, arrows, removal of text, removal of portions of text, removal of whole text, triggering of video, and inputting any customized content into the text.

The term “animation” as used herein and in the appended claims includes animation of text annotation, text definition, supporting illustration, and text manipulation.

The term “automatic animation” as used herein and in the appended claims means that the animation occurs automatically without any required input by the end users.

The term “text effect” as used herein and in the appended claims includes the effects of text annotation, text definition, supporting illustration, and text manipulation.

The term “text effect activation” as used herein and in the appended claims means that the text effect requires a prompt from the end users in order for the text manipulation to appear.

The term “prompt” as used herein and in the appended claims includes an input by the end users, wherein the input includes, but is not limited to, touching the text on the screen, using a mouse, and touching any key on a keyboard.

In one of the preferred embodiment, a method for educational instruction is provided, comprising the steps of: identifying the areas of study necessary for an individual to become a teacher (or another type of professional or for a teacher to maintain continuing education requirements or to become a better teacher); for each area of study, identifying all the individual topics that will be studied; for each individual topic, identifying (comprehensive and multidisciplinary) works needed for each individual topic, wherein the material may include, but is not limited to, film, literature, art, news articles, blogposts, music, and culture; ensuring that the works selected provides a thorough perspective of the individual topic; optionally consulting scholars in each individual topic to ensure that all relevant works are included; preparing sequencing of exploration of works selected such that each subsequent work builds off of the previous work; determining the appropriate length of time allocated for exploration of each individual topic; creating a set of questions and an answer key pertaining to the exploration of each work; and, optionally revising the works selected for each individual topic.

In another embodiment, an educational instruction kit is provided. The educational instruction kit includes all of the areas of study. For each area of study, the kit also includes all of the individual topics, all of the works, the sequence for exploration of the works, and the set of questions for each work.

In an embodiment, the method of educational instruction is for the continuing education of teachers rather than for children or education majors or teaching certification students.

In another preferred embodiment, the appropriate length of time allocated for thorough exploration of a topic is from 21 to 36 hours. In some instances, it is envisioned that the appropriate length of time allocated for thorough exploration of a topic may be shorter than 21 hours and longer than 36 hours.

In summary, the method for educational instruction provides professional development classes for individuals pursuing professions in the business and education sectors. The classes utilize a multidisciplinary approach to comprehensively explore topics that are interesting and beneficial to the career development of the individuals. In preparing the classes, research is conducted for topics in a variety of contemporary and historical humanities fields including: science, history, literature, music, film, television, geography, architecture, urban planning, mathematics, politics, economics, and journalism.

The topics are thematically organized to include multimedia clips from film, Youtube®, documentaries, literature, and news articles. The individual class components build incrementally off of one another. Additionally, scholars are consulted in specific fields relevant to the subject matter explored for research and development purposes. The classes for professionals are held over several days, months or even multi-year time frames, building in time for discussion, reflection, and future application of individuals' learning experiences in their respective fields. The classes are revised perpetually to provide thorough perspectives and research. Benefits of the method for educational instruction include the thorough exploration of a topic through literature, art, music, history, documentary, and other disciplines in the humanities to ensure a comprehensive, multidisciplinary, and through understanding of the topic. In a preferred embodiment, at least 23 disciplines are explored for each topic. This thorough exploration of a topic occurs regardless of the topic, that is, a through exploration is conducted whether the topic is a painting, a fiction or nonfiction work, a musical work, or some other topic. For each topic, the work is studied in the context of its historical era, the author's cultural context and biography, and in relation to other texts from other time periods and places and/or similar time periods and places.

Additionally for each topic, the work is closely studied for language analysis, rhetorical devices, narrative techniques, musical techniques, and artistic techniques. When an author's cultural context is explored it is done so using the author's biography (written and/or multimedia supplements), information about the author's historical era, and events that influenced the author (written and/or multimedia supplements). The multimedia used includes but isn't limited to: documentary found on TV, online; film; television; news clips; music videos; interviews; and audio works including interviews with authors, scholars, music, talk shows, radio shows, et cetera. Connections are found between works studied in a particular series. Students (who may be teachers or may be studying to be teachers) are asked to make connections between earlier sessions and later sessions. Students are asked to think about how themes and ideas from works in one session relate to themes and ideas in works from an earlier session. Further, students are asked to make connections to themes from other courses.

The courses incorporate scholarly criticism or commentary on the works as they are explored. The criticism or commentary may come from field experts or university professors who study the works and/or the authors of the works. The criticism or commentary may be in written form or may be a multimedia work such as a video or audio interview.

The students are asked to connect themes in the works to ideas from the past, present, and future. The events may be actual events or imagined or proposed events. The students are asked to think of the practical application of ideas in works. The students are asked a series of questions that may include: “what does this mean for us today?”, “how do themes in a written work connect to themes or ideas people suggest today?”, “what was the author trying to teach humanity and how might this be relevant for today?”, or “how do we see the language of a rhetorical written work applied today?”. Ultimately, individual topics are comprehensively explored using a multidisciplinary approach, thereby providing a thorough understanding of all of the topics and how they relate to topics in other courses. This approach ensures a fuller understanding of the topics and encourages the students to recognize connections between other topics and courses that would not otherwise be found.

Method of Educational Instruction through Text Analysis, Creation of Educational Tools, and Populating a Platform with Educational Tools

It is the objective of the present disclosure to provide a method for educational instruction that includes selection of at least one text, performing text analysis on the at least one text, wherein the text analysis of the at least one text includes creation of a narrative, creation of a narration script, creation of an animation script, and creation of a final script, wherein the narrative, narration script, animation script, and final script are used in the creation of at least one educational tool, wherein the at least one educational tool is used to populate a platform, and wherein end users are able to access the at least one educational tool on the platform.

### Text Analysis Method

A method of text analysis is described. The steps include: steps 1 and 2, identifying areas of study and selecting at least one area of study; steps 3 and 4, identifying topics within the area of study and selecting at least one topic; steps 5 and 6, identifying texts within the topic and selecting at least one text; step 7, identifying which of the categories (music, picture books, prose, poetry, or art) the text fits into, step 8, performing text analysis on the at least one selected text within a topic based on the category that the text fits into. Optionally, scholarship analysis may be performed on the text); step 9, performing text analysis by identifying text devices used in the text and selecting at least one text device that has been used in the text; step 10, identifying words, phrases, or components of the text that are useful for understanding the selected text device used in the text; step 11, develop a narrative explaining the text analysis; step 12, optionally develop a narration script based on the narrative; step 13, develop an animation script based on the narrative; step 14, optionally develop a final script to merge the narration script and the animation script; and step 15, creating an educational tool for the text using the results of the text analysis; wherein the educational tool is at least one of: an animated video tool; and instructional tool; or a student tool.

It is understood that the above method can be performed without the step of creating an educational tool. That is, this method can be used in a face to face setting, rather than by way of an educational tool.

### Text Analysis Method for Music Texts

In an embodiment where the text is a music text, the text includes, but is not limited to lyrics, musical scores, and audio music. In this embodiment, the text analysis includes the following steps:

1. Briefly review the text to identify and select at least one theme and/or at least one argument of the text.
2. Identify, select, and analyze at least one word choice of the author in the text in order to identify why the at least one word choice is used within the sentence and what purpose this word serves in relation to the theme and/or argument of the text.
3. Analyze syntax in the text to determine why a sentence is broken up by commas and what purpose this serves for the theme and/or argument.
4. Analyze sentence construction to determine why there is a periodic sentence versus a loose sentence (or vice versa) and how this relates to the theme and/or argument.
5. Analyze prosody in a text to determine how this relates to the theme and/or argument.
6. Analyze pacing in the text to determine how this relates to the theme and/or argument.
7. Identify, select, and analyze at least one rhetorical device to determine why these are used and/or how they are used to support the theme and/or argument.
8. Identify, select, and analyze at least one narrative technique to determine how the author's selection of the at least one narrative technique supports the theme and/or argument.
9. Identify, select, and analyze at least one literary technique to determine how the author's at least one literary technique supports the theme and/or argument.
10. Identify a central theme to demonstrate how the elements in steps 2 through 9 construct thematic patterns in the text to support the theme and/or argument.
11. Research, identify, and analyze scholarly texts to determine what other scholars say about the text. This step may be performed in combination with the other steps as necessary.
12. Identify and explain the author's cultural context, including the author's historical context and the author's cultural background, to determine how these inform the text through thematic patterns and/or word choices.
13. Research, identify, and select at least one supporting multimedia of the text.
14. Identify connections of the text to at least one other connecting text from another academic discipline to determine how the connecting text informs the theme and/or argument of the text.
15. Identify and analyze rhythm and meter of the text.
16. Identify and analyze rhyme scheme of the text.
17. In an embodiment where the music text is a musical score, identify and analyze measure, key, key change, tempo, instrumental variety, chord, conductor's directions, rests, construction of pieces and movements, volume, and any other relevant information in the text.
18. Analyze the combined effects of the elements identified in steps 1 through 17 on the audio of the text.
19. Compile the analysis from steps 1 to 18 to develop a narrative explaining the analysis. Develop a narration script based on the narrative. Develop an animation script is based on the narrative. Develop a final script to merge the narration script and the animation script.

It will be appreciated that not all of the above steps are required for every musical text and that the method may be performed in any order and is not limited to the order presented above.

### Text Analysis Method for Picture Book Texts

In an embodiment where the text is a picture book text, the text analysis includes the following steps:

1. Briefly review the text to identify and select at least one theme and/or at least one argument of the text.
2. Identify, select, and analyze at least one word choice of the author in the text in order to identify why the at least one word choice is used within the sentence and what purpose this word serves in relation to the theme and/or argument of the text.
3. Analyze syntax in the text to determine why a sentence is broken up by commas and what purpose this serves for the theme and/or argument.
4. Analyze sentence construction to determine why there is a periodic sentence versus a loose sentence (or vice versa) and how this relates to the theme and/or argument.
5. Analyze prosody in a text to determine how this relates to the theme and/or argument.
6. Analyze pacing in the text to determine how this relates to the theme and/or argument.
7. Identify, select, and analyze at least one rhetorical device to determine why these are used and/or how they are used to support the theme and/or argument.
8. Identify, select, and analyze at least one narrative technique to determine how the author's selection of the at least one narrative technique supports the theme and/or argument.
9. Identify, select, and analyze at least one literary technique to determine how the author's at least one literary technique supports the theme and/or argument.
10. Identify a central theme to demonstrate how the elements in steps 2 through 9 construct thematic patterns in the text to support the theme and/or argument.
11. Research, identify, and analyze scholarly texts to determine what other scholars say about the text. This step may be performed in combination with the other steps as necessary.
12. Identify and explain the author's cultural context, including the author's historical context and the author's cultural background, to determine how these inform the text through thematic patterns and/or word choices.
13. Research, identify, and select at least one supporting multimedia of the text.
14. Identify connections of the text to at least one other connecting text from another academic discipline to determine how the connecting text informs the theme and/or argument of the text.
15. Identify, select, and analyze at least one poetic device used in the text in order to determine how this relates to the theme and/or argument.
16. Analyze at least one illustration used in the text in order to determine how this supports the theme and/or argument.
17. Determine the purpose of the at least one illustration in order to determine what the illustration conveys about the theme and/or argument.
18. Compile the analysis from steps 1 to 17 to develop a narrative explaining the analysis. Develop a narration script based on the narrative. Develop an animation script is based on the narrative. Develop a final script to merge the narration script and the animation script.

It will be appreciated that not all of the above steps are required for every picture book text and that the method may be performed in any order and is not limited to the order presented above.

### Text Analysis Method for Prose Texts

In an embodiment where the text is a prose text, the text analysis includes the following steps:

1. Briefly review the text to identify and select at least one theme and/or at least one argument of the text.
2. Identify, select, and analyze at least one word choice of the author in the text in order to identify why the at least one word choice is used within the sentence and what purpose this word serves in relation to the theme and/or argument of the text.
3. Analyze syntax in the text to determine why a sentence is broken up by commas and what purpose this serves for the theme and/or argument.
4. Analyze sentence construction to determine why there is a periodic sentence versus a loose sentence (or vice versa) and how this relates to the theme and/or argument.
5. Analyze prosody in a text to determine how this relates to the theme and/or argument.
6. Analyze pacing in the text to determine how this relates to the theme and/or argument.
7. Identify, select, and analyze at least one rhetorical device to determine why these are used and/or how they are used to support the theme and/or argument.
8. Identify, select, and analyze at least one narrative technique to determine how the author's selection of the at least one narrative technique supports the theme and/or argument.
9. Identify, select, and analyze at least one literary technique to determine how the author's at least one literary technique supports the theme and/or argument.
10. Identify a central theme to demonstrate how the elements in steps 2 through 9 construct thematic patterns in the text to support the theme and/or argument.
11. Research, identify, and analyze scholarly texts to determine what other scholars say about the text. This step may be performed in combination with the other steps as necessary.
12. Identify and explain the author's cultural context, including the author's historical context and the author's cultural background, to determine how these inform the text through thematic patterns and/or word choices.
13. Research, identify, and select at least one supporting multimedia of the text.
14. Identify connections of the text to at least one other connecting text from another academic discipline to determine how the connecting text informs the theme and/or argument of the text.
15. Compile the analysis from steps 1 to 14 to develop a narrative explaining the analysis. Develop a narration script based on the narrative. Develop an animation script based on the narrative. Develop a final script to merge the narration script and the animation script.

It will be appreciated that not all of the above steps are required for every prose text and that the method may be performed in any order and is not limited to the order presented above.

### Text Analysis Method for Poetry Texts

In an embodiment where the text is a poetry text, the text analysis includes the following steps:

1. Briefly review the text to identify and select at least one theme and/or at least one argument of the text.
2. Identify, select, and analyze at least one word choice of the author in the text in order to identify why the at least one word choice is used within the sentence and what purpose this word serves in relation to the theme and/or argument of the text.
3. Analyze syntax in the text to determine why a sentence is broken up by commas and what purpose this serves for the theme and/or argument.
4. Analyze sentence construction to determine why there is a periodic sentence versus a loose sentence (or vice versa) and how this relates to the theme and/or argument.
5. Analyze prosody in a text to determine how this relates to the theme and/or argument.
6. Analyze rhythm in order to determine how this relates to the theme and/or argument.
7. Analyze rhyme scheme and line breaks and determine how this relates to the theme and/or argument.
8. Identify, select, and analyze at least one rhetorical device to determine why these are used and/or how they are used to support the theme and/or argument.
9. Identify, select, and analyze at least one narrative technique to determine how the author's selection of the at least one narrative technique supports the theme and/or argument.
10. Identify, select, and analyze at least one literary technique to determine how the author's at least one literary technique supports the theme and/or argument.
11. Identify a central theme to demonstrate how the elements in steps 2 through 10 construct thematic patterns in the text to support the theme and/or argument.
12. Research, identify, and analyze scholarly texts to determine what other scholars say about the text. This step may be performed in combination with the other steps as necessary.
13. Identify and explain the author's cultural context, including the author's historical context and the author's cultural background, to determine how these inform the text through thematic patterns and/or word choices.
14. Research, identify, and select at least one supporting multimedia of the text.
15. Identify connections of the text to at least one other connecting text from another academic discipline to determine how the connecting text informs the theme and/or argument of the text.
16. Compile the analysis from steps 1 to 15 to develop a narrative explaining the analysis. Develop a narration script based on the narrative. Develop an animation script is based on the narrative. Develop a final script to merge the narration script and the animation script.

It will be appreciated that not all of the above steps are required for every poetry text and that the method may be performed in any order and is not limited to the order presented above.

### Text Analysis Method for Art Texts

In an embodiment where the text is an art text, the text analysis includes the following steps:

1. Analyze color usage in the text, including identifying why the artist used certain colors and how those colors are used.
2. Analyze shading in the text to determine how some colors are used to create shadows; if relevant, analyze how lighting is manipulated.
3. Identify the type of art of the text and medium used in the text.
4. Identify usage of lines and shapes to create images in the text.
5. Identify perspective to determine how and where the viewer's gaze is directed.
6. Identify the theme of the work to determine how the elements of steps 1 through 5 come together to create a story within the text.
7. Research, identify, and analyze scholarly texts to determine what other scholars say about the text. This step may be performed in combination with the other steps as necessary.
8. Identify and explain the author's cultural context, including the author's historical context and the author's cultural background, to determine how these inform the text through thematic patterns and art styles)
9. Research, identify, and select at least one supporting multimedia of the text.
10. Identify connections of the text to at least one other connecting text from another academic discipline to determine how the connecting text informs the theme and/or argument of the text.
11. Compile the analysis from steps 1 to 10 to develop a narrative explaining the analysis. Develop a narration script based on the narrative. Develop an animation script based on the narrative. Develop a final script to merge the narration script and the animation script.

It will be appreciated that not all of the above steps are required for every art text and that the method may be performed in any order and is not limited to the order presented above.

### Method for Creating an Educational Tool

A method for creating an educational tool wherein the educational tool is an animated video tool, a student tool, or an instructional tool to be described presently.

### Animated Video Tool

In an embodiment wherein the educational tool created is an animated video tool, first a text video is created. Next, audio narration and animation are created and added to the text video to create the animated video tool. The animated video tool effectively demonstrates the text analysis of the text.

### Step 1: Text Video

In step 1, the text is copied and pasted (or scanned) into a video creation program electronically and, in step 1b, the printed/formatted text is used to create a text video. The text video is approximately 1 to 20 minutes in length, or 30 seconds to 2 hours. In other embodiments, the video may be 2 hours in length. In a preferred embodiment, the video creation program creates a text video that is in MP4 format. MP4 formatting is well known in the arts and thus will not be further discussed herein. Other video formats are within the scope of this disclosure. Examples of other video formats include, but are not limited to, 3gp, m4v, rmvb, 3gp2, mp3, rv, avi*, way, EVRC, QCELP, wma, fly, ra, wmv, iv4, ram, m4a, and rm.

### Step 2: Audio Narration

Audio narration of the text analysis is added to the text video. In step 2a, a narration script is developed based on the text analysis. In particular, the narration script includes a discussion of the words, phrases, and components identified in the text analysis. In step 2b, the script is read by a narrator or narrators and is audio recorded. The audio narration can be recorded by any available recording device. In a preferred embodiment, the recorder is a tascam recorder.

### Step 3: Text Annotation and Animation

First, in step 3a, an animator reviews the animation script to determine what type of annotation to use for the identified words, phrases, and components of the text as identified in the text analysis. Next, in step 3b, the animator creates text annotation in the text such that the text annotation is animated and timed to coordinate with the discussion of the text annotation in the audio narration.

### Step 4: Text Definition and Animation

In step 4a, the animator reviews the animation script to determine what words, phrases, and components require a text definition. In step 4b, the animator creates text definition in the text such that the text definition is animated and timed to coordinate with the discussion of the text defining in the audio narration.

### Step 5: Supporting Illustration and Animation

In step 5a, the animator reviews the animation script to determine what supporting illustrations are required for the text. In step 5b, the animator adds the required supporting illustrations to the text and animates the supporting illustrations and times the animation to coordinate with the discussion (if any) of the supporting illustration.

### Step 6: Text Manipulation and Animation

In step 6a, the animator reviews the animation script to determine what text manipulation is required. In step 6b, the animator creates text manipulation in the text such that the text manipulation is animated and timed to coordinate with the discussion of the text manipulation in the audio narration.

### Step 7: Animated Video Tool Assembly

Once the above steps are completed, in step 7a, a final script is reviewed in order to merge the narration script and the animation script. In step 7b, the audio narration is added to the text video and the animation is sequentially embedded into the text video, as per the instructions in the final script, thereby creating an animated video tool. In step 7c, the animated video tool is digitized so that it can be uploaded onto a web platform. The animation can be created by any method of animation known in the art, including by using software programs such as After Effects® and Flash®. These programs and other methods of creating animation generally are well known to those of skill in the art and are not further described herein. As can be appreciated, the steps of the method of creating an animated video tool can be performed in any order. Although described sequentially as steps 1 through 7, the method is not so limited. Moreover, in some instances, steps 3-6 may need to be repeated several times in order for all of the animations to be created. The number of animated video tools is almost limitless.

Optionally, at the end of each animated video tool, there may be suggestions for further study that includes links to books, articles, and other multimedia. The identification of these books, articles, and other multimedia is done as part of the optional scholarship analysis.

Optionally, additional supporting multimedia (either video or audio or both) may be added to the animated video tool. The selection of this material is done as part of the optional scholarship analysis. The source of the multimedia may be NPR®, PRX®, YouTube®, PBS®, and other media outlets. The multimedia may be excerpted and embedded directly into the animated video tool. Alternatively, the multimedia may be suggested to the end user by way of a link to the multimedia, wherein the multimedia is not embedded directly into the animated video tool.

In its final form, the animated video tool is ready to be played as a streaming video. The end user is able to view the animated video tool, which includes the text video with audio narration and animation. As the text video plays, the audio narration will explain the animation, thereby providing a thorough analysis and discussion of the text. While the text video tool is intended to be played from finish to end, it is possible to pause the text video tool and rewind and fast forward the text video tool. In a preferred embodiment, the animation of the text is automatic animation.

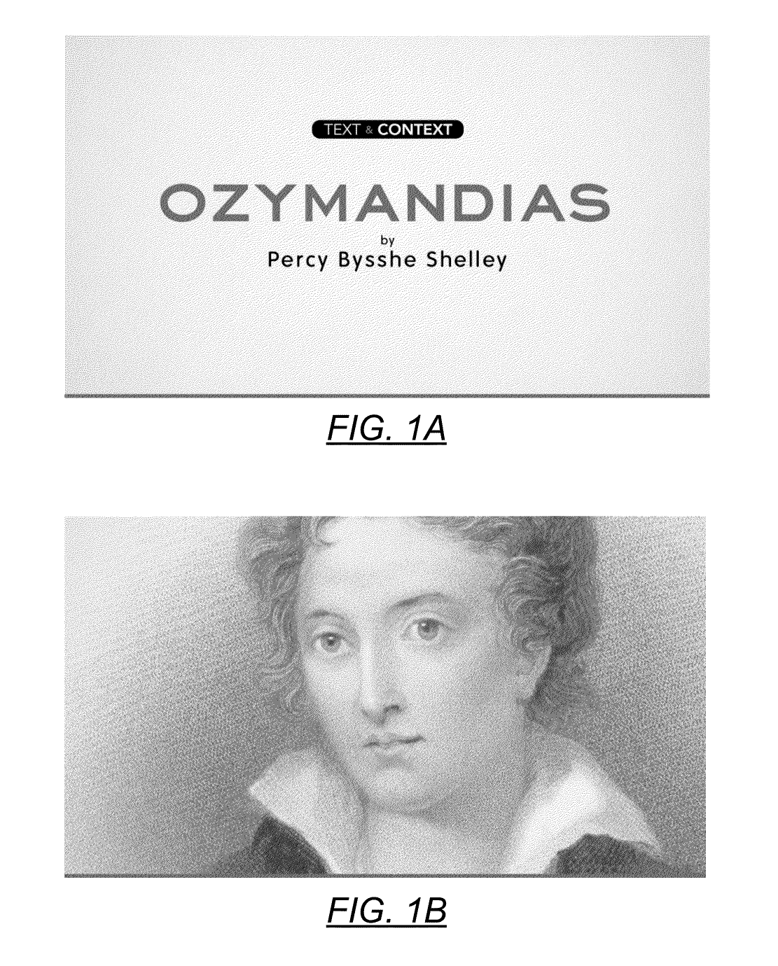

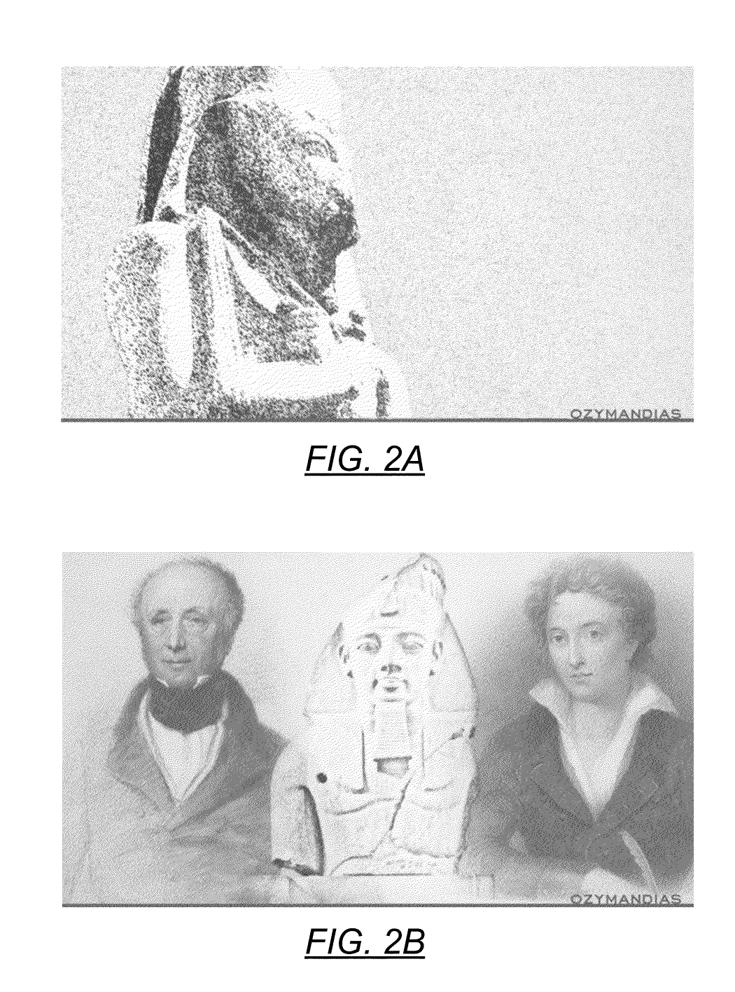

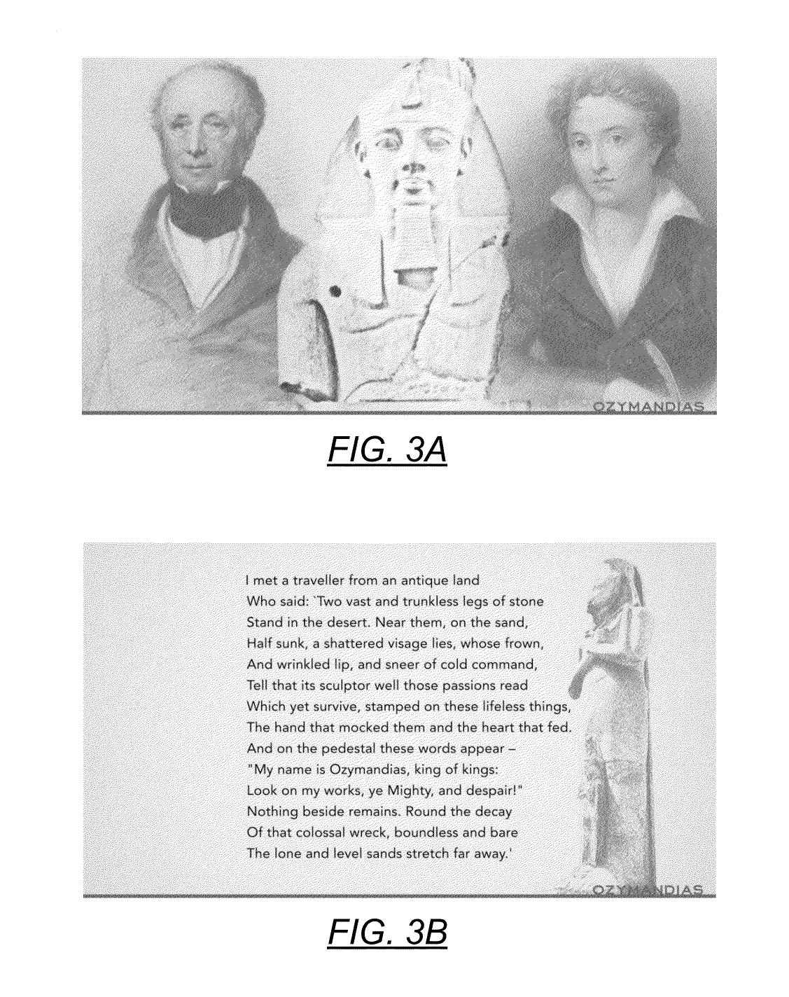

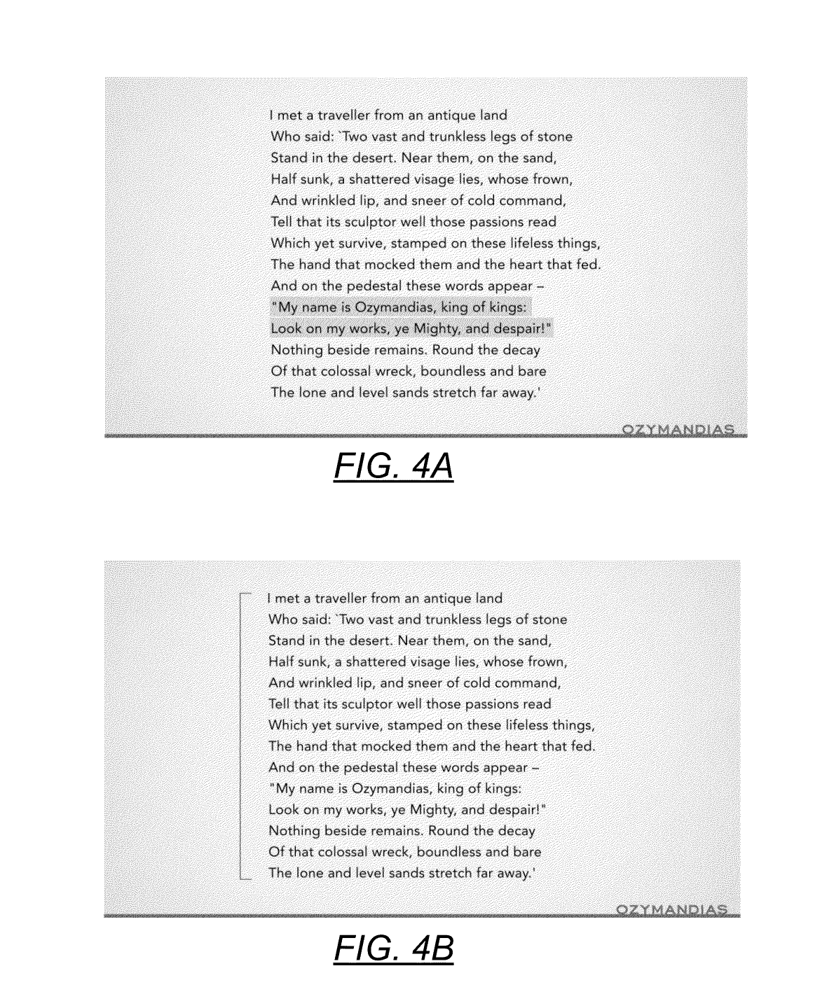

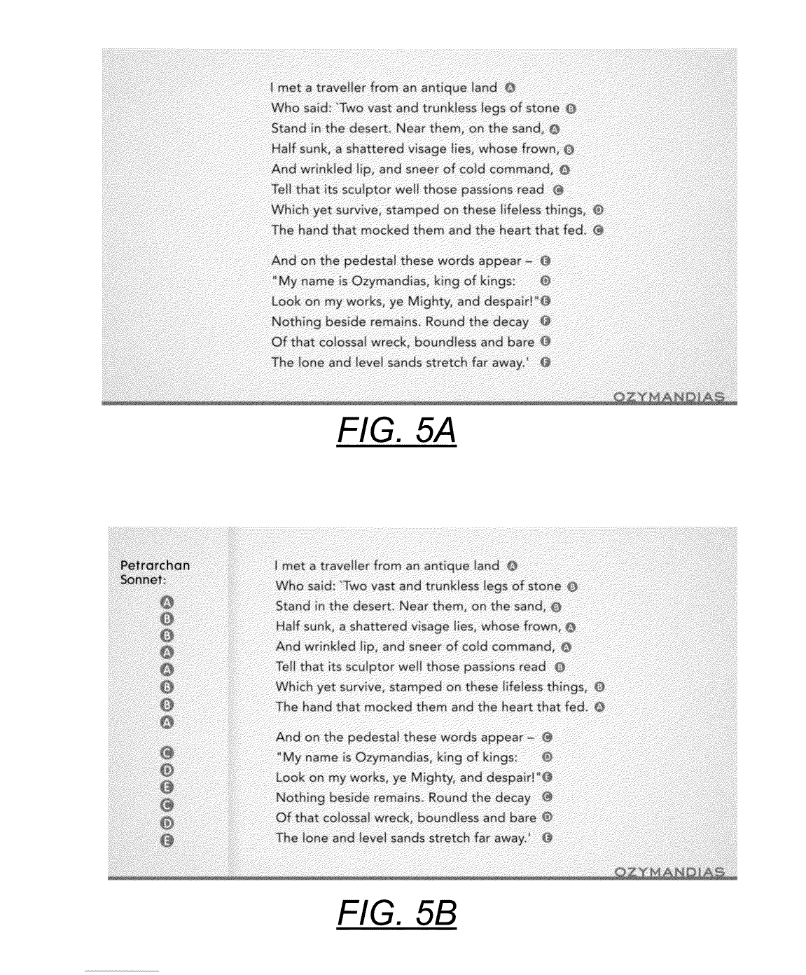

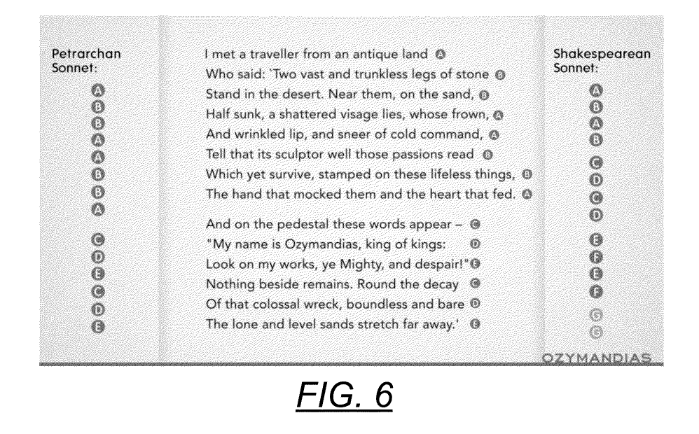

FIGS. 1-6 depict screenshots of an animated video tool of a poetry text. FIG. 1A depicts an introduction screen with the title of the selected poetry text. As the animated video tool plays, narration corresponds to supported illustrations, such as those in FIG. 1B, which depicts the image of the poet, and FIG. 2A, which depicts the image of the subject of the poetry text, and FIG. 2B, which depicts images of other poets who also wrote about the same subject of the poetry text, and FIG. 3A, which depicts the text manipulation (magnification) of the subject of the poetry text. In FIG. 3B, the poetry text is depicted. FIG. 4A depicts highlighted text demonstrating theme as identified in the text analysis and FIG. 4B depicts text annotations (bracketing) of text demonstrating theme as identified in the text analysis. FIG. 5A depicts animation that demonstrates the rhyme scheme of the poetry text. FIG. 5B depicts the rhyme scheme of the poetry text as it relates to established rhyme schemes. FIG. 6 depicts another rhyme scheme for comparison to the rhyme scheme selected by the author of the poetry text.

### Instructional Tool

In an embodiment wherein the educational tool created is an instructional tool, first a text video is created. Next, text effects are added to the text video to create the instructional tool. The instructional tool effectively demonstrates the text analysis of the text.

### Step 1: Text Video

In step 1 a, the text is copied and pasted (or scanned) into a digitized format or put into a video creation program electronically and, in step 1 b, the digitized/printed/formatted text, is used to create a text video. The text video can be any length and in some embodiments, the text video is approximately 1 to 3 minutes in length. In other embodiments, the video may be 2 hours in length. In a preferred embodiment, the video creation program creates a text video that is in MP4 format. MP4 formatting is well known in the arts and thus will not be further discussed herein. Other video formats are within the scope of this disclosure. Examples of other video formats include, but are not limited to, 3gp, m4v, rmvb, 3gp2, mp3, rv, avi*, way, EVRC, QCELP, wma, fly, ra, wmv, iv4, ram, m4a, and rm.

### Step 2: Text Annotation

First, in step 2a, an animator reviews the animation script to determine what type of annotation to use for the identified words, phrases, and components of the text as identified in the text analysis. Next, in step 2b, the animator creates text annotation in the text such that the text annotation is a text effect that appears in the text video upon text effect activation when an end user inputs a prompt.

### Step 3: Text Definition

In step 3a, the animator reviews the animation script to determine what words, phrases, and components require a text definition. In step 3b, the animator creates text definition in the text such that the text definition is a text effect that appears in the text video upon text effect activation when an end user inputs a prompt.

### Step 4: Supporting Illustration

In step 4a, the animator reviews the animation script to determine what supporting illustrations are required for the text. In step 4b, the animator adds the required supporting illustrations to the text and animates the supporting illustrations such that the supporting illustrations are text effects that appears in the text video upon text effect activation when an end user inputs a prompt.

### Step 5: Text Manipulation

In step 5a, the animator reviews the animation script to determine what text manipulation is required. In step 5b, the animator creates text manipulation in the text such that the text manipulation is a text effect that appears in the text video upon text effect activation when an end user inputs a prompt.

### Step 6: Text Note Insertion

The instructional tool also has a feature to embed the end user's personal notes into the instructional tool for text effect activation upon prompting of the text effect.

Step 7: Instructional Tool Assembly Once the above steps are completed, in step 7a, the text effects are embedded into the text video, as per the instructions in the final script, thereby creating an instructional tool. In step 7b, the instructional tool is digitized so that it can be uploaded onto a web platform. The text effects can be created by any method of animation known in the art, including by using software programs such as After Effects® and Flash®. These programs and other methods of creating animation generally are well known to those of skill in the art and are not further described herein.

As can be appreciated, the steps of the method of creating an animated video tool can be performed in any order. Although described sequentially as steps 1 through 6, the method is not so limited. Moreover, in some instances, steps 2-5 may need to be repeated several times in order for all of the animations to be created. The number of instructional tools is almost limitless.

Optionally, at the end of each instructional tool, there may be suggestions for further study that includes links to books, articles, and other multimedia. The identification of these books, articles, and other multimedia is done as part of the optional scholarship analysis.

Optionally, additional supporting multimedia (either video or audio or both) may be added to the instructional tool. The selection of this material is done as part of the optional scholarship analysis. The source of the multimedia may be NPR®, PRX®, YouTube®, PBS®, and other media outlets. The multimedia may be excerpted and embedded directly into the instructional tool. Alternatively, the multimedia may be suggested to the end user by way of a link to the multimedia, wherein the multimedia is not embedded directly into the instructional tool.

In its final form, the instructional tool is ready to be used by the end user. The end user is able to view the text effects of the instructional tool by using prompts to cause text effect activation on the screen. When the end user wants to show a text effect of a certain word, the end user will use a prompt on that word. In one embodiment, it is possible to prompt text effect activation of a word that wasn't selected to have a text effect.

### Student Tool

In an embodiment wherein the educational tool created is a student tool, first a text video is created. Next, audio narration and animation and text effects are created and added to the text video to create the student tool. The student tool effectively demonstrates the text analysis of the text.

### Step 1: Text Video

In step 1 a, the text is copied and pasted (or scanned) into a video creation program electronically and, in step 1 b, the printed/formatted text is used to create a text video. The text video can be any length and in some embodiments, the text video is approximately 1 to 3 minutes in length. In other embodiments, the video may be 2 hours in length. In a preferred embodiment, the video creation program creates a text video that is in MP4 format. MP4 formatting is well known in the arts and thus will not be further discussed herein. Other video formats are within the scope of this disclosure. Examples of other video formats include, but are not limited to, 3gp, m4v, rmvb, 3gp2, mp3, rv, avi*, way, EVRC, QCELP, wma, fly, ra, wmv, iv4, ram, m4a, and rm.

Step 2: Audio Narration Audio narration of the text analysis is added to the text video. In step 2a, a narration script is developed based on the text analysis. In particular, the narration script includes a discussion of the words, phrases, and components identified in the text analysis. In step 2b, the script is read by a narrator and is audio recorded.

The audio narration can be recorded by any available recording device. In a preferred embodiment, the recorder is a tascam recorder.

### Step 3: Text Annotation and Animation

First, in step 3a, an animator reviews the animation script to determine what type of annotation to use for the identified words, phrases, and components of the text as identified in the text analysis. Next, in step 3b, the animator creates text annotation in the text such that the text annotation is animated and timed to coordinate with the discussion of the text annotation in the audio narration. In step 3c, the animator may create text annotation in the text such that the text annotation is a text effect that appears in the text video upon text effect activation when an end user inputs a prompt.

### Step 4: Text Definition and Animation

In step 4a, the animator reviews the animation script to determine what words, phrases, and components require a text definition. In step 4b, the animator creates text definition in the text such that the text definition is animated and timed to coordinate with the discussion of the text definition in the audio narration. In step 4c, the animator may create text definition in the text such that the text definition is a text effect that appears in the text video upon text effect activation when an end user inputs a prompt.

### Step 5: Supporting Illustration and Animation

In step 5a, the animator reviews the animation script to determine what supporting illustrations are required for the text.

In step 5b, the animator adds the required supporting illustrations to the text and animates the supporting illustrations and times the animation to coordinate with the discussion (if any) of the supporting illustration. In step 5c, the animator may create text supporting illustration in the text such that the supporting illustration is a text effect that appears in the text video upon text effect activation when an end user inputs a prompt.

### Step 6: Text Manipulation and Animation

In step 6a, the animator reviews the animation script to determine what text manipulation is required. In step 6b, the animator creates text manipulation in the text such that the text manipulation is animated and timed to coordinate with the discussion of the text manipulation in the audio narration. In step 6c, the animator may create text manipulation in the text such that the text manipulation is a text effect that appears in the text video upon text effect activation when an end user inputs a prompt.

### Step 7: Student Tool Assembly

Once the above steps are completed, in step 7a, a final script is reviewed in order to merge the narration script and the animation script. In step 7b, the audio narration is added to the text video and the animation is sequentially embedded into the text video and the text effects are embedded into the text video, as per the instructions in the final script, thereby creating an animated video tool. In step 7c, the student tool is digitized so that it can be uploaded onto a web platform. The animation and text effects can be created by any method of animation known in the art, including by using software programs such as After Effects® and Flash®. These programs and other methods of creating animation generally are well known to those of skill in the art and are not further described herein.

As can be appreciated, the steps of the method of creating a student tool can be performed in any order. Although described sequentially as steps 1 through 7, the method is not so limited. Moreover, in some instances, steps 3-6 may need to be repeated several times in order for all of the animations to be created. The number of student tools is almost limitless.

Optionally, at the end of each student tool, there may be suggestions for further study that includes links to books, articles, and other multimedia. The identification of these books, articles, and other multimedia is done as part of the optional scholarship analysis.

Optionally, additional supporting multimedia (either video or audio or both) may be added to the student tool. The selection of this material is done as part of the optional scholarship analysis. The source of the multimedia may be NPR®, PRX®, YouTube®, PBS®, and other media outlets. The multimedia may be excerpted and embedded directly into the animated video tool. Alternatively, the multimedia may be suggested to the end user by way of a link to the multimedia, wherein the multimedia is not embedded directly into the student tool.

In its final form, the student tool is ready to be played as a streaming video. The end user is able to view the student tool, which includes the text video with audio narration and animation. As the text video plays, the audio narration will explain the animation, thereby providing a thorough analysis and discussion of the text. While the student tool is intended to be played from finish to end, it is possible to pause the text video tool and rewind and fast forward the text video tool. In a preferred embodiment, the animation of the text is automatic animation. The student tool also allows the end user to view the text effects by using prompts to cause text effect activation on the screen. When the end user wants to show a text effect of a certain word, the end user will use a prompt on that word. In one embodiment, it is possible to prompt text effect activation of a word that wasn't selected to have a text effect.

### Secondary Text Analysis

A secondary text analysis may be performed in order to create an embedded tool bar into the educational tool. The secondary text analysis may be performed after the last step of the text analysis method or may be done after the creation of the educational tool.

The secondary text analysis is performed by, in step 1, identifying words within the text that are important or useful for understanding the text. In step 1a at least one word used in the text is selected. In step 1 b, the at least one word is defined. In step 2, a search is performed to identify external resources, including, but not limited to newspaper articles, multimedia references, books, and other pertinent resources that reference the text. In step 2a, at least one external resource is selected. In step 3, at least one discussion question pertaining to the text is developed. The at least one discussion question may be developed based on the text analysis discussed above.

For example, the at least one discussion question may pertain to the theme or argument of the selected text.

The results of the secondary text analysis are then incorporated into an tool bar that is embedded into the educational tool. The embedded tool bar has three components, a vocabulary tool bar, a resources tool bar, and a discussion tool bar. The at least one word identified, selected, and defined in step 1 is used in the vocabulary bar. The at least one external resource identified in step 2 is used in the resources tool bar. The at least one discussion question developed in step 3 is used in the discussion tool bar. It will be appreciated that in some instances not all three components of the embedded tool bar are used or required. It will also be appreciated that the embedded tool bar is not required for use in every educational tool and in one embodiment, the embedded tool bar is only used in the animated video tool.

The embedded tool bars flow throughout the play of the educational tool and display at predetermined times for a predetermined amount of time. At any time, the end user can pause the tool bar so as to allow more time to view the information provided in the tool bar.

### Vocabulary Tool Bar

The vocabulary tool bar provides the definitions of words that are identified and selected in the text as useful.

### Resources Tool Bar

The resources tool bar contains links to the external resources. Depending on the type of external resource selected, the link may be an embedded hyperlink or may be information to locate the external resource, such as the name of a book that can be purchased later.

In the resources tool bar, the end user can trigger a stoppage of play so that he or she can click on an external link in the case that there is a link. Discussion Tool Bar The discussion tool bar contains questions that the end users can use to discuss elements of the educational tool with the other end users. When the discussion tool bar appears, the educational tool will stop playing and end users have a predetermined finite period of time to work through the discussion questions. When the predetermined finite period of time is up, a timer goes off. At this point, the end users have an opportunity to input a submission, including a discussion summary and any questions, into the platform.

The end user submissions are sent to the educational tool platform administrator and stored electronically in the platform. The administrator responds to the questions and the responses are sent to all of the end users participating in the discussion. In one embodiment, the discussion summary and questions and responses will be used to create a document that the end users can download and/or print for future reference or use in the classroom or for use in studying. After the discussion tool bar has been played, the educational tool resumes playing.

In one embodiment, a group of end users may have 5 minutes to work through 3 questions, then a video timer goes off. Then the group of end users has 2 minutes to record responses to the discussion questions and input them into the platform.

### Educational Tool Platform

Once finalized, the educational tools can be uploaded onto a computer database, thereby creating an educational tool platform. Uploading of the educational tools is done through a content management system that has searching and tagging capabilities. In one embodiment, the educational tool platform is an online computer database and the educational tools are viewable in a web browser. In another embodiment, the educational tool platform is a closed and secured system. The educational tool platform is an end user's portal to access the educational tools. The end user has login information (including a unique pin) that allows access to educational tools upon logging into the educational tool platform. The platform recognizes each end user's login information, such that the particular login information allows that end user access to certain educational tools only. In some cases, the end user's login information may only allow the end user to view one educational tool, while another end user's login information may allow access to several or all of the educational tools on the educational tool platform. After the end user views an educational tool, the time and date and length of viewing time is automatically logged by the educational tool platform and reports are generated to administrators of the educational tool platform. Once finished viewing, the end user uses the login information to log off of the platform.

If more than one end user is present, each end user must provide login information so that each end user is accounted for on the platform. Once finished viewing, each end user is required to log off of the platform using login information. This allows the administrators of the educational tool platform to keep accurate records of the educational tools that were viewed by the end users. Within the platform there is a custom video player that allows the end user to view the educational tools, namely, the animated video tool and the student tool. The custom video player includes overlays of the three tool bars (vocabulary, resources, and discussion), that appear in the educational tool. The custom video player is capable of allowing the administrators to pre-program times the custom video player will pause automatically and a built in timer that alerts the end user to move on from a pause. The platform is also capable of receiving input from the end users and input from the administrators to create documents suitable for downloading. The custom video player allows end users to stop viewing the video and save the session and later resume watching the video at the point at which the end user stopped viewing the video. The educational tool platform and custom video player is compatible on nearly any device, a desktop computer, a laptop computer, a tablet, smartphone, or any other such similar device.

In a preferred embodiment, the educational tool platform is developed using php with C++, the use of which are well known in the art and thus will not be discussed further herein. In another preferred embodiment, the content of the educational tools is programmed using HTML 5 so that it is visible on nearly any device. The use of HTML 5 is well known in the art and thus will not be further discussed herein. In another embodiment, the web browser is created using javascripts and css, the use of which is well known in the art and thus will not be further discussed herein. In another embodiment, the database is programmed using Mysequel, the use of which is well known in the art and thus will not be further discussed herein.

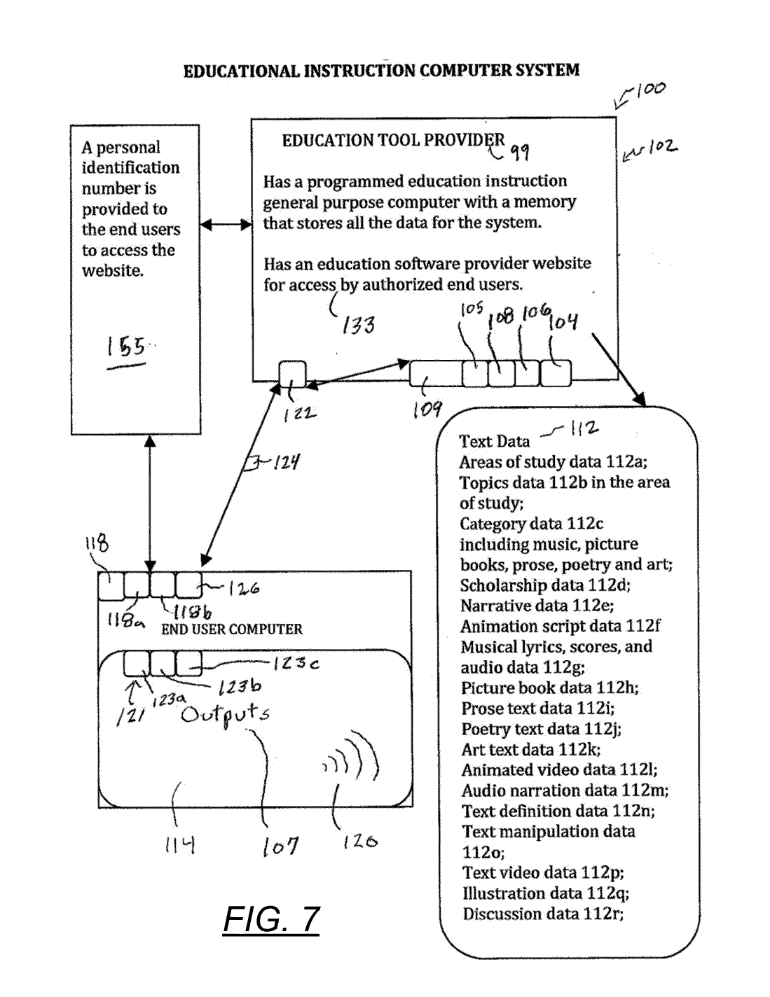

Presently, the use of the educational tool will be described. As shown in FIG. 7, there is also a system 100 provided for carrying out the method of educational instruction 102 provided by an educational tool provider 99. The system 100 includes a programmed education instruction general purpose computer 104 having a central processing unit 106 and a memory component 108 that is owned by the education service provider 99. The central processing unit 106, among other tasks, carries out the instructions of the education computer software program 105 that has been preprogrammed in the programmed education instruction general purpose computer 104. The memory component 108 is for storing tool data 109 pertaining to the method of education instruction 102, and includes at least the following tool data 109 including text data 112: Text data 112 that includes data for at least each of the following: areas of study data 112a; topics data 112b in the area of study; category data 112c including music, picture books, prose, poetry and art; scholarship data 112d; narrative data 112e; animation script data 112f musical lyrics, scores, and audio data 112g; picture book data 112h; prose text data 112i; poetry text data 112j; art text data 112k; animated video data 112i; audio narration data 112m; text definition data 112n; text manipulation data 112o; text video data 112p; illustration data 112q; and, discussion data 112. The memory component 108 may be embodied as a standard memory component, the use and operation of which are well known to those having ordinary skill in the art and are therefore not described in greater detail herein.

The central processing unit 106 uses and processes the text data 112 that includes the areas of study data 112a; topics data 112b in the area of study; category data 112c including music, picture books, prose, poetry and art; scholarship data 112d; narrative data 112e; animation script data 112f; musical lyrics, scores, and audio data 112g; picture book data 112h; prose text data 112i; poetry text data 112j; art text data 112k; animated video data 112i; audio narration data 112m; text definition data 112n; text manipulation data 112o; text video data 112p; illustration data 112q; and, discussion data 112r. The processed data is then used to generate educational tools. The act of programming a computer, for example the programmed education instruction general purpose computer 104, to execute instructions in order to carry out the functions described above is well known to those having ordinary skill in the art and is therefore not described in greater detail herein.

The central processing unit 106 is capable of generating outputs 107 that can be displayed on a display screen 114 of a programmed end user computer 118 (that may be student computers or educational institution computers), and is also capable of generating audible outputs 120 broadcasted by the programmed end user computer 118. The end user computer 118 has an end user computer central processing unit 118a, an end user computer memory 118b and the end user computer screen display 114.

There is also an interface component 122 associated with the programmed education instruction general purpose computer 104 to allow access to the Internet 124. The use and operation of the Internet 124 is well known to those having ordinary skill in the art and is therefore not described in greater detail herein.

In addition, the end user computer 118 has an end user computer interface component 126 and it is in communication with the programmed education instruction general purpose computer 104 by way of end user computer interface component 126 over the Internet 124. The end user computer interface component 126 is capable of transmitting and allowing for the flow incoming and outgoing of the above-described data between the programmed education instruction general purpose computer 104 and the end user computer 118. The end user computer interface component 126 also allows for graphical presentations to be viewed on the end user computer screen display 114. Interface components, such as the interface component 124 and end user computer interface component 126, are well known to those having ordinary skill in the art and include any combination of hardware, firmware, or software in a computer used to enable communication or data transfer between the computer and a device, system, or network external to the computer, and can connect with a system, or network external to the programmed education instruction general purpose computer 104 and end user computer 118 programmed education instruction general purpose computer 104, using, for example, a hardwire connection, an optical connection, an Internet connection, or a radio frequency connection, and all of these types of connections are well known to those having ordinary skill in the art.

In addition, the programmed education instruction general purpose computer 104 is programmed such that the end user computer 118 displays a toolbar 121 and the toolbar 121 has tabs 123a that link to third party websites such as NPR®, YouTube®; PBS®, newspapers; and tabs 123b that link to dictionaries and reference books. The tool bar 121 also includes a tab 123c for discussions that allows the user to communicate with others for purposes of discussions.

In addition, in one of the preferred embodiments in order for the end user to access an education provider website 133 provided by the educational tool provider 99, a personal identification number (PIN) 155 must be inputted. The programmed education instruction general purpose computer 104 verifies whether or not the PIN 155 is authentic. If it is not authentic, then access to the education provider website 99 is denied.

In another preferred embodiment there is no access to the Internet 124 and the education computer software program 105 that is installed on the programmed education instruction general purpose computer 104 is installed directly on the end user computer 118 or an end user computer network (not shown). A PIN 155 is required to open the application for security purposes.

### EXAMPLES

### Example 1

For a text selected within a topic within an area, the text analysis includes studying the language, including word choice, literary structure, narrative devices, rhetorical devices, syntax, linguistic devices, poetic meter, and theme. Optionally an analysis of illustrations (e.g. in a children's book) is conducted. The analysis includes studying the style of illustration (with attention to type of illustration (painting, drawing, or photograph), type of paint if a painting, style of illustration, for example, impressionistic, black and white or color if a drawing or photograph), the intent, the influence of the illustration on language, and the influence of illustration on theme. The result of this process is a text analysis, which is then corroborated by university professors and in the field and other field experts and historians.

In instances where the topic is an author, the text will include an analysis of the author's cultural context, including, but not limited to the author's biography and life, and how these two aspects of the author's experience influences the creation of a particular work by that author. Additionally, the analysis may also include the historical context of the author, including, the political, social, economic, financial, and cultural circumstances of the author's life and how these circumstances influenced the creation of the work. The author's particular experiences and circumstances are readily available in journals, books, articles and other resources, but the analysis of how it influences the author's work(s) is created through the method disclosed herein, resulting in a text analysis.

The words or phrases that are animated may be literary structures, syntactical devices, metrical devices, and/or words of importance to the text. The animation may also include providing a definition of important words in an animated note in a note margin.

In one embodiment, the animation provides information about literary structure by identifying through annotation (underlining or circling) of the literary structure in the text, identifying the type of literary structure used in the text in the notes margin and providing a definition of the particular type of literary structure used in the text. In another embodiment, the animation provides information about syntactical devices or metrical devices in the same manner as just described. In another embodiment, the animation includes embedded images.

In another embodiment, another text and text analysis may be included for a contrast and comparison between the two texts and the two text analyses. In this case, the texts may be selected from the same or different disciplines. This may be done so as to demonstrate a theme that crosses disciplines.

### Example 2

The Story of Ruby Bridges is paired with a short story by Kate Chopin and artwork by Normal Rockwell. The text analysis identifies the use of multiple voices used in narration in the main text including the narrator's voice, Ruby's voice, Mother's voice, and the teacher's voice). The text analysis also identifies the tan color of the illustrations, the allusions to slavery, the class issue, and the connection of the text to the Gospels.

### Example 3

In Lon Po Po, the Book of Tao is paired with this text. The text analysis identifies the connections to Little Red Riding Hood, the images of the wolf hidden on each page, the panel paintings as related to Chinese panel paintings, the use of subliminal spaces—including dusk and sunset, the signs Shang picks up on using her senses, and the signs the wolf misses.

### Example 4

A student thoroughly and comprehensively explores the essay “Civil Disobedience,” by exploring American art from the Romantic Era as a means of understanding the cultural context. A student exploring “Civil Disobedience,” will learn (among other things) what was happening in the U.S. and world in the mid-1800s, what was happening in Thoreau's life at the time, what influenced him early in his childhood, college career, and early professional career to help him write Civil Disobedience, how the ideas and themes in Civil Disobedience connect to ideas and themes in writings by Gandhi, Dr. King, Rosa Parks, and other authors, and finally how Thoreau's ideas influenced Emerson, Thomas Cole, and other authors from his era.

Additionally, while studying “Civil Disobedience,” students will explore narrative structure, prose, sentence structure, word choice, tone, mood, metaphors, simile, argument of the work, and will analyze the work with other tools such as anaphora, epistrophe, cascade, synecdoche, chiasmus, parallelism and balance, antithesis, et cetera. The students will also explore connections Thoreau made to themes in Dante's Inferno, which is a work from an earlier era.

### Example 5

When a student studies a painting from the Romantic Era, he or she will study painting technique, placement of objects, foreground and background, shadow and lighting, shapes of objects, et cetera.

### Example 6

A student studying “Uncle Tom's Cabin,” will watch a video reenactment of Harriet Beecher Stowe explaining her upbringing, her preaching Father and the debates he had in his house, life experiences such as going to church and seeing a Judge's wife weep, experiences that impacted her work such as her time on a Kentucky plantation, what she felt while writing the text (including her feelings concerning the loss of her child and what happened after), and other items of information that may be relevant.

### Example 7

A student studying “Catch-22,” will view a video interview of the author, Joseph Heller, explaining where his frame of mind was when he wrote the work and what influenced his thinking from the army and the post war period of the 1950s.

### Example 8

Students will be asked to consider how themes from one course to another course or courses. For example, how does the theme of “What Does It Mean to be an American” tie to themes in “Global Literacy 1” or “Award Winning Narratives.”

### Example 9

When students study the “Last of the Mohicans”, the students will watch a video from Cooper scholar Bob Daly, from The University at Buffalo, who gives a perspective on Cooper and his work in relation to his era.

### Example 10

When students explore The Maori indigenous group, they will study the writings of a scholar on Maori history.

### Example 11

When students explore “The Snowy Day”, they will see a video of a scholar in a Jewish Museum giving criticism on Keats and the picture book.

### Example 12

When students study argument and persuasion in writing, they will read blogs that are comments by readers of articles; such as blogs from Facebook® and other social networking sites.

### Example 13

When students explore “The Great Gatsby”, they will study the causes of the Depression and behaviors of the stock market and link this to causes of the recent recession and the stock market; subsequently the students will be instructed to think of The Great Gatsby as related to the crash of '29 and other works that relate to the recent recession that are similar in theme.

Further disclosed is a method of making an educational tool for a user using a computing device, e.g., general purpose computer, having a processor and a memory. As a first step, associating at least one trait with is associated with a literary style to form a literary style database in the memory. A literary style includes, but is not so limited to, the implications of the use of punctuations, e.g., commas, dashes, quotations, semi-colons, etc., in a text, alliteration, assonance, consonance, chiasmus, parallelism, anadiplosis, anaphora, epistrophe, cascade, end stopping, asyndeton, simile, narration, conjunction, tenses, and imagery, etc. This is followed by performing text analysis on at least one selected text in the processor. This step includes determining the frequency of an occurrence of at least one item of a trait in the selected text in a pre-determined range. No pre-programmed items are required although in certain circumstances, a user may specify the exact items to be detected, e.g., a frequency that tallies the number of occurrences of the word “you” in a sentence within the selected text in a pre-determined range. Upon obtaining the frequency of an occurrence of an item of a trait, a difference is obtained by subtracting a pre-determined value from the frequency of occurrence of the item of the trait. If the difference is positive, i.e., if the frequency of occurrence is greater than the pre-determined value, a relevance value of the trait is obtained by dividing the difference with the pre-determined value. The pre-determined value can be adjusted to adjust the “prominence” of an item of a trait in determining the literary style. For example, an item is the subject of a search, the pre-determined value can be decreased such that the resulting relevance value or difference/pre-determined value is increased as the difference will be greater and the pre-determined value will be smaller. The resulting trait is then compared to literary styles already established earlier in the literary style database to identify a literary style. This is followed by ordering the at least one item of the trait in a list according to the magnitude of the relevance value such that a user can expediently obtain the top traits identified from the selected text. This process is repeated until all words in a text have been processed. A new text is then processed just as the previous has been processed. This ordered list can be presented to the user graphically or in textual format. This method aids a user in identifying text that interests a user and reduces the amount of time and effort required to process text manually in order to identify the materials of interest. In addition, it may aid the user in detecting new patterns and words in the text that are new to the user.

In one embodiment, two words is the minimum needed for repetition, and most likely to occur in works of children's literature and poetry. The Applicants discovered that a text length of 1,298 is the average length of longer samples of paragraphs, found in works such as the Appendix from the Narrative of the Life of Frederick Douglass. The longer samples are examined in one session. Anything longer samples would be two excerpts, and would not take place in one session.

In one embodiment, the item can be a letter, word, plurality of words, part of a word, punctuation mark and conjunction. One example of a part of a word is the “par” portion in “parch” of “parched.” The following examples disclose the types of literary styles considered in the present application:

### Commas:

The use of more than 3 commas in a given sentence, in the middle of a poetic line, or at the end of a poetic line is significant for reasons that that it: slows the line down, breaks up the rhythm at which a human reads and creates individual clauses. This technique is used by writers for reasons that it: lowers the pace at which a reader reads the line, indicates a pattern and relationship among clauses separated by commas, balances clauses in a sentence for comparison/contrast and creates parallel structures for comparison/contrast. Applying the concept disclosed elsewhere herein, if 5 commas are detected in a given sentence and with the pre-determined value of 3, the difference can be shown to be (5-3) or 2. The relevance value is then difference/pre-determined value or ⅔ or 0.67.

A comma in the middle of poetic line (often called a medial caesura) is significant for reasons that it: abruptly stops a line of verse, creates contrast and variance between lines of poetry, i.e., one smooth metrical line, one disrupted metrical. This technique is used by poets for reasons that it: gives consideration to the subject matter of a line of poetry, i.e., significance of words previous to comma; indicates change in emotion through contrast between metrical lines; indicates a pattern and relationship among clauses separated by commas.

A comma at the end of poetic line (often called end stopping) is significant for reasons that it: abruptly ends a line of verse to disrupt the metrical reading into the next line; gives consideration to the word before the comma. This technique is used by poets for reasons that it: makes the reader pause in a metrical reading of verse before moving onto the next line; suggests importance of the word before the comma in relation to the thematic development within a stanza.

### Dashes:

The use of more than 2 dashes in a sentence, or more than 3 dashes in a text. Dashes are significant for reasons that it: creates the effect of hypotactic language; slows the line down; suggests a reasoned argument with many independent and dependent clauses. This technique is used by writers for reasons that it: suggests a logical flow in building an argument; deliberately lowers the pace of a line for comparison/contrast of clauses; gives equal consideration and balance between clauses. Applying the concept disclosed elsewhere herein, if 6 dashes are detected in a given sentence and with the pre-determined value of 2, the difference can be shown to be (6-3) or 3. The relevance value for this first condition is then difference/pre-determined value or 3/2 or 1.5. The relevance value for the second condition is then difference/pre-determined value or (9-3)/3 or 2 if a total of 9 dashes are detected in the text. An average relevance value is then computed to be (1.5+2)/2 samples or 1.75. If placed in an order list based on prominence of the relevance value, the implications of the use of dashes in this instance will rank more prominently than the use of commas from the above example as the relevance value of dashes of 1.75 is higher than the relevance value of commas of 0.67.

Therefore, when a user is informed of the relevance data, she may quickly focus on analyzing the implications of the use of dashes instead of commas in this example although the user may subsequently analyze the implications of the use of commas. If the analysis of other literary styles are also desired, a list containing a plurality of literary styles with their respective relevance values can be calculated and presented to the user to help the user prioritize her work.

### Quotations:

The lack of use of quotations and the use of pronouns in a text indicates a significant condition for the following reasons. Missing quotations are significant for reasons that it:

blurs the narrative voice; creates ambiguity between the spoken word and the thought. This technique is used by writers for reasons that it: creates a universal character experience; creates a narrative structure that mixes dialogue and recall of that dialogue among characters; creates an awareness in reader of uncertainty of interpretation; demonstrates the intersection of the primary narrator and the primary reader.

### Semi-Colons:

The use of a semi-colon more than 1 time in a given sentence, or more than 3 times in a text is significant for reasons that it: creates a series of independent clauses; slows the line down. This technique is used by writers for reasons that it: shows a relationship between the clauses using a pattern of sequencing or balanced subject matter; and gives equal consideration to subject matter in clauses.

### Alliteration:

The use of more than 2 words beginning with the same letter in a given sentence, or more than 4 words beginning with the same letter in a text is significant for reasons that: sounds such as the letter R have a calming effect, while sounds such as the letter S have a warning effect; letters such as B force a slowdown in pronunciation because of how one's mouth must form and shape to produce the sound; letters such as P force an exhalation of air because of how the mouth and lips must form to produce a sound. This technique is used by writers for reasons that it: creates an effect of sound and emotion through repetition of letter sounds; to speed or slow a line down by using the same letter sounds; to create an effect of rhyme through sound to suture linguistic, and thereby literary, ideas together.

### Assonance:

The use of a vowel that is repeated more than two times in a sentence, or more than 4 times in a text is significant for reasons that: repetition of vowel sounds convey a sense of poetry and rhyme; letters such as “0” are said to have a calming effect; repetition of vowel sounds effect our memories of the words, and the subject matter of those words. This technique is used by writers for reasons that it: creates an effect of sound and emotion through repetition of vowel sounds; has calming or exciting effects on the language and subsequent interpretation; creates an effect of rhyme through sound to suture linguistic, and thereby literary, ideas together.

### Consonance:

The use of the same consonant at the beginning or end of a word more than 2 times in a given sentence, or more than 4 times in a text is significant for reasons that: the repetition of letter sounds convey a sense of poetry and rhyme; letters such as “W” are said to have a calming effect; repetition of consonant sounds affect our memories of the words, and the subject matter of those words. This technique is used by writers for reasons that it: creates an effect of sound and emotion through repetition of vowel sounds; has calming or exciting effects on the language and subsequent interpretation; creates an effect of rhyme through sound to suture linguistic, and thereby literary, ideas together.

### Chiasmus:

The use of words that are repeated in following pattern, ABBA, in a given sentence, or in a text is significant for reasons that: the literary structure ABBA conveys that a change can occur without falling into chaos; that order and balance can be achieved even as a major idea is reexamined, even flip-flopped. This technique is used by writers for reasons that it: inspires a change in thinking in the audience for embracing a new idea; persuades the reader to follow the writer's argument, particularly when the reader is unaccustomed to the ideas in the argument.

### Parallelism:

The use of words that are repeated in following pattern, ABAB in a given sentence, or in a text is significant for reasons that: the literary structure ABAB conveys a sense of balance in grammatical structure and subject matter; and it creates comparison/contrast between 2 or more ideas. This technique is used by writers for reasons that it: compares and contrasts ideas, themes and other subject matter; conveys a sense of logic and reason in the writer's argument; gives equal consideration to two or more ideas.

### Anadiblosis:

The use of two words that are repeated one after the other is significant for reasons that it: retains the importance of an idea by starting another clause with the same idea; creates a sequence of direct repetition. This technique is used by writers for reasons that it: emphasizes the subject matter of the repetitive word; conveys a sense of rhyme through repetition as a persuasion device.

### Anaphora:

The use of the same word that is repeated at the beginning of 2 or more clauses, in a text is significant for reasons that it: to creates direct repetition of an idea; maintains balance through consistent phrases at the beginnings of clauses; retains consistency of thematic and subject development. This technique is used by writers for reasons that it: persuades the reader of the writer's argument; and develops the argument in the subject matter through consistency of phrasing.

### Epistrophe:

The use of the same word that is repeated at the end of 2 or more clauses, in a text is significant for reasons that it: creates direct repetition of an idea; maintains balance through consistent phrases at the ends of clauses; retains consistency of thematic and subject development. This technique is used by writers for reasons that it: persuades the reader of the writer's argument; develops the argument in the subject matter through consistency of phrasing; places the most important idea at the end of the clause, since readers remember that the best.

### Cascade:

The use a sentence that is broken into 2 or more clauses is significant for reasons that it: develops and builds an idea in increasing or decreasing intensity; shows the relationship of one clause to the next. This technique is used by writers for reasons that it: shows the spiraling effects of the subject matter; shows fizzling effects of a subject matter; shows how one idea (x) affects another idea (y) which affects another idea (z) and so on.

### End Stopping:

The use of a punctuation at the end of a line in verse is significant for reasons that it: abruptly stops a poetic line; pauses at the end of one metrical line without continuing on immediately to the next metrical line. This technique is used by poets for reasons that it: halts a thought or idea, as an abrupt change in subject matter from one line to the next; and gives pause and interrupts the metrical rhythm in the case of a partial change in subject matter and thematic development in the stanza.

### Asyndeton:

The use of a sentence that is broken into clauses without a conjunction is significant for reasons that it: gives equal weight to two or more clauses; pauses the line as the conjunction, which speeds the line, is omitted. This technique is used by writers for reasons that it: treats the subject matter of the clauses with equal importance; lowers the pace of the line and illustrate the effects of the subject matter more profoundly.

### Simile:

The use of the words “like” or “as” in a given sentence, followed by a noun within 5 words is significant for reasons that it: likens the subject matter with another noun for comparison; illustrates, through a storytelling technique, the narrative's objective through examples. This technique is used by writers for reasons that it: introduces a difficult or unfamiliar idea by using an easy or familiar reference; illustrates the universality in certain thematic developments through comparisons.

### Narration:

The use of “I” or “you” in a group of a text and narrative voice in the first or second person is significant for reasons that it: directly addresses the reader; creates a narrative witness as an authentication device. This technique is used by writers for reasons that it: increases aesthetic distance between the writer and reader; reduces aesthetic distance between the writer and reader; helps reader become privy to the thoughts and ideas of a character which would otherwise be difficult to ascertain, for example, through the third person.

### Conjunction:

The use of words such as or, and, but, yet, for, nor, and so is significant for reasons that it: speeds the line; connects two clauses and suggests dependency; gives a set of alternatives. This technique is used by writers for reasons that it: speeds the pace of a line and gives equal consideration to all parts of a sentence, such as the case with paratactic language; complicates an idea or theme and develops the complexity.

### Tenses (Past, Present, Etc.):

The use of present tense and the term “will” in a text is significant for reasons that: present tense suggests an idea, theme, or event happens repeatedly throughout history; past tense suggests an idea, theme, or event happened in the past, and is not necessarily a repeated occurrence; future tense suggests an insight into the future that the narrator and reader are privy to. This technique is used by writers for reasons that it: illustrates a recurring theme; and conveys a sense of timelessness.

### Imagery:

The use of an image that is repeated in first 4 paragraphs, or once in the first four paragraphs and once in the last two paragraphs is significant for reasons that it: connects an image with a narrative circumstance; creates a metaphor through an image; conveys an oxymoron, or related idea, through an image. This technique is used by writers for reasons that it: conveys the feelings of a character, or describes the setting or environment, through a metaphor; and connects a character development with an image.

It will be appreciated by those skilled in the art that while the method of educational instruction has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

What is claimed is:

1. A method of making an educational tool for a user using a computing device having a processor and a memory, said method comprising steps of:
(a) associating at least one trait with a literary style to form a literary style database in the memory; and
(b) performing text analysis on at least one selected text in the processor, said performing step comprising:
(i) determining the frequency of an occurrence of at least one item of a trait in said selected text in a pre-determined range;
(ii) subtracting a pre-determined value from the frequency of occurrence of said at least one item of said trait to result in a difference, wherein if said difference is positive, a relevance value of said trait is obtained by dividing said difference with said pre-determined value and said trait is looked up in said literary style database to identify a literary style; and
(c) ordering said at least one item of said trait in a list according to the magnitude of said relevance value such that top traits identified from the at least one selected text can be presented to the user.

2. The method of claim 1, wherein said occurrence is selected from the group consisting of:
(a) said at least one item of said trait occurring more than 3 times in a given sentence, in the middle of a poetic line, or at the end of a poetic line within said selected text in said pre-determined range;
(b) said at least one item of said trait occurring more than 2 times in a sentence, or more than 3 times within said selected text in said pre-determined range;
(a) said at least one item of said trait occurring zero times within said selected text in said pre-determined range and pronouns are present;
(c) said at least one item of said trait occurring more than 1 time in a given sentence, or more than 3 times within said selected text in said pre-determined range;
(d) said at least one item of said trait occurring more than 2 words beginning with the same letter in a given sentence, or more than 4 words beginning with the same letter within said selected text in said pre-determined range;
(e) said at least one item of said trait occurring more than 2 times in a sentence, or more than 4 times within said selected text in said pre-determined range;
(f) said at least one item of said trait occurring at the beginning or end of a word more than 2 times in a given sentence, or more than 4 times within said selected text in said pre-determined range;
(g) said at least one item of said trait occurring in conjunction with another item in ABBA order, in given sentence, or within said selected text in said pre-determined range;
(h) said at least one item of said trait occurring in conjunction with another item in ABAB order, in given sentence, or within said selected text in said pre-determined range;
(i) said at least one item of said trait occurring in conjunction with another item and this combination is repeated at least once within said selected text in said pre-determined range;
(j) said at least one item of said trait occurring at the beginning of 2 or more clauses within said selected text in said pre-determined range;
(k) said at least one item of said trait occurring at the end of 2 or more clauses within said selected text in said pre-determined range;
(l) said at least one item of said trait is broken into 2 or more clauses;
(m) said at least one item of said trait occurring at the end of a line in a verse;
(n) said at least one item of said trait is broken into clauses without a conjunction;
(o) said at least one item of said trait occurring in a given sentence, followed by a noun within 5 words;
(p) said at least one item of said trait occurring at least once within said selected text in said pre-determined range;
(q) said at least one item of said trait occurring at least once and present tense is used within said selected text in said pre-determined range; and
(r) said at least one item of said trait occurring at least once in first 4 paragraphs and once in the last two paragraphs.

3. The method of claim 2, wherein said at least one item of said trait is selected from the group consisting of a letter, word, plurality of words, sentence, part of a word, punctuation mark and conjunction.

4. The method of claim 1, wherein said pre-determined range ranges from 2 to about 1,298 words.

5. The method of claim 1, further comprising:
(a) performing scholarship analysis on the text; performing text analysis by identifying text devices used in the text and selecting at least one text device that has been used in the text;
(b) identifying and selecting at least one word, phrase, or component of the text that is useful for understanding the selected text device used in the text; and
(c) developing a narrative explaining the at least one word, phrase, or component of the text.

6. The method of claim 5, further comprising:
(a) developing a narration script based on the narrative; and
(b) developing an animation script based on the narrative.

7. The method of claim 6, further comprising:
(a) developing a final script to merge the narration script and the animation script;
creating a text video of the text;
(b) creating at least one animated text effect based on the animation script; and
(c) merging the text video and at least one text effect to create an educational tool.

8. The method of claim 7, wherein the educational tool is selected from the group consisting of an animated video tool, instructional tool, and a student tool.

9. The method of claim 8, wherein the educational tool is an animated video tool and the method further comprises:
(a) creating and recording an audio narration based on the narration script; and
(b) merging the text video, audio narration, and at least one text effect such that the at least one text effect is timed to appear in the video at the same time that the audio narration is discussing the at least one text effect.

10. The method of claim 9, wherein the at least one text effect is selected from the group consisting of an animated text annotation, an animated text definition, an animated supporting illustration, and an animated text manipulation.

11. The method of claim 10, wherein the at least one text effect is present in the animated video tool.

12. The method of claim 11, wherein the method further comprises the step of creating animated text effects on all content of the text in addition to the selected at least one word, phrase, or component.

13. The method of claim 8, wherein the at least one text effect is selected from the group consisting of an animated text annotation, an animated text definition, an animated supporting illustration, and an animated text manipulation.

14. The method of claim 13, wherein the at least one animated text effect appears in the text video upon text effect activation, wherein the text effect activation occurs as a result of prompting by an end user.

15. The method of claim 14, wherein the animated text effects appear in the text video upon text effect activation, wherein the text effect activation occurs as a result of prompting by an end user.

16. The method of claim 8, wherein the educational tool is a student tool and the method further comprises:
creating and recording an audio narration based on the narration script; merging the text video, audio narration, and at least one text effect such that the at least one text effect is timed to appear in the video at the same time that the audio narration is discussing the at least one text effect.

17. The method of claim 16, wherein the at least one text effect is selected from the group consisting of an animated text annotation, an animated text definition, an animated supporting illustration, and an animated text manipulation.

18. The method of claim 17, wherein the at least one animated text effect appears in the text video upon text effect activation, wherein the text effect activation occurs as a result of prompting by an end user.

19. The method of claim 18, wherein the method further comprises the step of creating animated text effects on all content of the text in addition to the selected at least one word, phrase, or component.

20. The method of claim 19, wherein the animated text effects appear in the text video upon text effect activation, wherein the text effect activation occurs as a result of prompting by an end user.
